(19) United States
(12) Patent Application Publication
(10) Pub. No.: US 2003/0022083 A1
(43) Pub. Date: Jan. 30, 2003

(54) Magnetic toner and image forming method

(76) Inventors: Masahisa Ochiai, Fukaya-shi (JP); Toshihiko Noshiro, Kumagaya-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/138,564

(22) Filed: May 6, 2002

(30) Foreign Application Priority Data
May 7, 2001 (JP) 2001-136425

(51) Int. Cl. G03G 9/083

(52) U.S. Cl. 430/106.1; 430/111.41; 430/108.6; 430/108.7

(57) ABSTRACT

A magnetic toner is provided which can satisfactorily form an image by using a non-magnetic one-component developing system. The magnetic toner comprising a magnetic powder, a binder resin and a wax is subjected to a surface treatment with using a composite external additive composed of two kinds of external additives different in primary particle diameter.

### DETAILED DESCRIPTION OF THE INVENTION

1. Field of the Invention

The present invention relates to a toner used in an image forming method of a non-magnetic one-component developing system of an electro-photographic process, an electrostatic printing process, an electrostatic recording process or the like, and, more particularly, to a magnetic toner suitable for forming magnetic characters which are read by a magnetic ink character recognition (hereinafter abbreviated as “MICR”) system.

2. Description of the Prior Art

An image forming method of an electrophotographic system, an electrostatic recording system or the like is applied to OA equipment such as a copying machine, a printer, a facsimile or the like. There has been well known, for example, an image forming method using an electrophotographic system in which an electrostatic latent image on the surface of a photosensitive member is turned into a toner image with using a developer, and this toner image is transferred onto a medium such as paper or the like, and the medium having the toner image transferred thereonto is made to pass through heating rollers, and thereby the toner image is fixed to the medium.

As developers, there are a two-component developer composed of a toner and a carrier, and a one-component developer composed of only a toner without any carrier. The one-component developer is composed of a coloring agent dispersed in a binder resin. In such a toner, there are a magnetic toner and a non-magnetic toner. The magnetic toner is further composed of a magnetic powder such as black magnetite or the like mixed in the binder resin used as a main component, and therefore is suitable for forming a monochromatic image.

Since the black color of the magnetite is an obstacle to coloring of an image, there has been increased a demand for a non-magnetic one-component developer composed of a non-magnetic toner. Furthermore, in recent years, high-speed image formation has been strongly demanded in addition to the above-mentioned coloring. It is said that the non-magnetic one-component developer is suitable for such high-speed image formation.

In a developing system using such a non-magnetic one-component developer, the non-magnetic toner is electrically charged during image formation in order to turn, into a toner image, an electrostatic latent image formed on the surface of a photosensitive member. Electrification of the non-magnetic toner is generally performed by a triboelectric charging method in which the non-magnetic toner to be carried to a developing roller is made to pass between the surface of the developing toner and a tip of an elastic blade, the tip which is press-contacted with the surface of the developing roller.

Meanwhile, recently, with the spread of an image forming apparatus such as an electrophotographic copying machine or the like, the use of the image forming apparatus has become diverse, and thus there has been contrived a character printer used in an MICR system as the application field of an electrophotographic printer.

This MICR system has mainly been contrived to print information about a drawing bank, an amount of money, an account number and the like on a check or a bill or the like with using magnetic ink, and efficiently sort or classify the check or the bill in a bill clearing house or the like by a magnetic reader. Although offset printing that uses magnetic ink has conventionally been mainstream, a demand for a small-sized MICR character printer (hereinafter referred to as “an MICR encoder”) has been increased as business transactions with a personal check or bill or the like are increased.

An impact printer applying a thermal copying system has been mainstream in the above-described MICR encoder. In this case, however, most of the MICR encoders have a single function of printing only MICR characters, and so cannot be used for making general documents. Thus, it is expected that a multi-purpose electro-photographic printer appears which is capable of printing general documents and/or graphics and printing the above-mentioned MICR characters and which has a good MICR recognition rate.

### SUMMARY OF THE INVENTION

Since the MICR printing uses a toner containing a magnetic powder, there is performed a magnetic one-component developing system which uses a magnetic one-component developer or a magnetic two-component developing system which uses a magnetic two-component developer obtained by mixing a magnetic toner and a magnetic carrier. That is, the MICR printing is performed by a so-called developing system which uses the magnetic toner.

However, the magnetic one-component developing system or the magnetic two-component developing system using the magnetic toner is small in an amount of electric charge and low in electrically charged speed, in comparison with a non-magnetic one-component developing system which uses a non-magnetic toner or a non-magnetic two-component developing system which is obtained by mixing a non-magnetic toner and a non-magnetic carrier. Therefore, high-speed development thereof is difficult.

Meanwhile, since an apparatus in the two-component developing system requires a mechanism for mixing a carrier and a toner in comparison with the one-component developing system, the miniaturization of the apparatus cannot be achieved. In recent years, there has been a strong demand for a small size and a high speed thereof.

Further, in the magnetic developing system using the magnetic toner, the specific gravity thereof becomes great and the toner consumption thereof is increased in comparison with the non-magnetic developing system using the non-magnetic toner.

Therefore, it is preferable to perform printing in the non-magnetic developing system by using the magnetic toner. In particular, it is preferable that the magnetic toner can be used in the non-magnetic one-component developing system because the miniaturization and the high speed of the apparatus can be achieved at the same time.

However, if the conventional MICR toner for the magnetic one-component developer is used in the non-magnetic one-component developing system which can develop at a high speed, a satisfactory image density cannot be obtained and much fog portions happen because the amount of electric charge is small. Moreover, since the non-magnetic one-component developing system makes the toner press-contacted between the developing roller and the elastic blade and thereby triboelectrically charged, such drawback has arisen in the conventional magnetic toner that durability thereof degenerates and thereby the magnetic toner is attached to the blade and the like.

An object of the present invention is to provide a magnetic toner that can apply to a non-magnetic one-component developing system to form MICR magnetic characters.

A magnetic toner according to the present invention is a toner used in a one-component developing system, and is characterized by containing a magnetic powder, a binder resin and a wax, wherein the magnetic toner is applied to an image forming method based on a non-magnetic one-component developing system. The surface of said magnetic toner is characterized by including a plurality of kinds of external additives that are different in primary particle diameter and differences of which are within a range of 5 to 50 nm in volume average particle diameter.

It is preferable that said magnetic powder have a residual magnetization of 24 to 40 emu/g after the application of 10 k oersted. It is preferable that the content of said magnetic powder in the magnetic toner according to the present invention is less than 35 weight percent. It is preferable that said magnetic toner have a residual magnetization of 7 to 20 emu/g.

Another invention is an image forming method that is used in a non-magnetic one-component developing system developing an electrostatic latent image formed on the surface of a photosensitive member with using a magnetic toner, said magnetic toner is characterized by employing the magnetic toner recited in any one of the above descriptions. The non-magnetic one-component developing system is a developing system comprising at least: a photosensitive member; an electric charger for electrically charging the surface of the photosensitive member; an exposing device for forming an electrostatic latent image on the surface of the photosensitive member; a transferring device for transferring a toner image formed on the photosensitive member onto a member to be transferred; a developing roller opposite to the photosensitive member (in which no permanent magnet is provided); an elastic blade press-contacted with the developing roller; and a toner hopper for supplying the toner to the developing roller.

According to each of the above-described inventions, if the residual magnetization of the magnetic powder is less than 24 emu/g, the rate of the magnetic powder to be added in order to obtain the residual magnetization of the required toner becomes too large, so that the electrostatic property of the toner becomes no good, and thereby a developing property is reduced. In contrast, if the residual magnetization exceeds 40 emu/g, the toner is easily coagulated. Accordingly, it is preferable that the residual magnetization is within a range of 24 to 40 emu/g. Much preferably, the residual magnetization is within a range of 27 to 38 emu/g.

The residual magnetization of the magnetic toner is preferably within a range of 7 to 20 emu/g. If the residual magnetization is less than 7 emu/g, the recognition rate (i.e., the magnetic intensity) is reduced. In contrast, if it exceeds 20 emu/g, the toner is easily coagulated.

Further, the magnetic powder contained in the magnetic toner is determined such that the residual magnetization of the magnetic toner falls within a proper range, and therefore the content of the magnetic powder is preferably less than 35 weight percent.

It is preferable that an amount of triboelectric charging is within a range of −10 to −70 μc/g in negative electrification while being within a range of +5 to +50 μc/g in positive electrification.

The binder resin may be selected from resin having properties in accordance with a fixing system, such as styrene-acrylic base resin, polyester base resin, epoxy base resin, phenoxy resin or the like. The fixing system suitable for the present invention is a heat roll fixing, a flash fixing, and an oven fixing.

The magnetic powder may employ a magnetic powder having a comparatively large coercive force or residual magnetization, such as magnetite, Ba ferrite, Sr ferrite or the like, and may employ a combination of two or more kinds thereof. The shape of the magnetic powder depends upon a crystal, and a granular powder is more difficult to expose to the surface of the toner than an acicular powder, and therefore has preferably a superior capability of coercing the electrification and high stability because the leakage of the electrification thereof is difficult to induce. Each size of the magnetic powder is preferably equal to or less than 1.0 μm.

In order to enhance affinity to the binder resin and improve dispersability in the toner, it is preferable that the surface of the magnetic powder is subjected to a hydrophobic treatment with a titanate coupling agent or a silane coupling agent or the like. Since the electrostatic or developing property of the toner is degraded if the rate of the magnetic powder is great, the content of the magnetic powder in the toner should be set to a quantity at which the residual magnetization required for magnetically reading can be provided. By doing so, it is preferable that the shortage of a tone of color or a black color of the toner is compensated with carbon black or a coloring agent such as a dye pigment or the like.

The wax is added to enhance surface flatness of a printed surface. As the wax may be used low-molecular-weight polyethylene, polypropylene, an ethylene-propylene copolymer, denatured polyethylene, denatured polypropylene, a Fischer-Tropsch wax, a Southall wax, a montan wax, a galvanizing wax or the like. An added quantity thereof is preferably within a range of about 1 to 6%. It is preferable that the wax is uniformly dispersed in the toner. The wax may be dispersed in advance in the binder resin.

The electrification control agent is selected in accordance with the polarity of the toner. As a property of negative electrification, a chrome azo complex, an iron azo complex, a salicylic acid metal complex, calix arene and the like are preferable while as that of positive electrification, a nigrosine dye, a phenylmethane base dye and the like are preferable.

### DESCRIPTION OF THE PREFERRED EMBODIMENTS

A preferred embodiment of the present invention will be below described with reference to examples. In the examples described below, there will be used an image forming apparatus for a non-magnetic one-component developing system having the following configuration.

The image forming apparatus used in the examples has a basic configuration comprising: a negatively charged OPC photosensitive member formed in a drum shape; and a charger, an exposing device, a developing roller, a transferring charger and a cleaner which are arranged in this order so as to be opposite to the circumferential surface of the photosensitive member. The developing roller has a conductive shaft connected to a bias voltage source and has a conductive elastic layer, such that development in a contact developing system can be performed in a developing region that is opposite to and arranged on the OPC photosensitive member. No magnetic field generating means such as a permanent magnet or the like is provided in the developing roller.

Note that, in the above-described configuration, the OPC photosensitive member may not be formed in a drum shape, and may be formed in a belt shape which has been known well. Furthermore, the magnetic toner according to the present invention can be also applied to a non-magnetic one-component developing system of a non-contact development type.

The OPC photosensitive member is uniformly charged at the surface thereof by the charger while being rotated at a constant peripheral speed. However, a scorotron for corona discharge may be used as such charger. Besides the corona discharging, roller charging, brush charging or magnetic brush charging may be used.

The surface of the charged OPC photosensitive member is further subjected to optical image exposure by the exposing device, so that an electrostatic latent image is formed on the surface of the OPC photosensitive member. Such electrostatic latent image is transported into the developing region in which the developing roller is opposite thereto and arranged thereon while supported by the surface of the rotated OPC photosensitivity member. The electrostatic latent image is electrostatically supported on the surface of the developing roller connected to the bias voltage source, and is visualized as a toner image by the magnetic toner of the present invention, the magnetic toner which has been transported into the developing region.

The magnetic toner used in the above-described non-magnetic one-component developing system is agitated by an agitator inside of a toner hopper. First, the magnetic toner is supported on the surface of a replenishment roller rotated, and then is transferred to and supported on the surface of the developing roller adjacent thereto and rotated and applied to a potential difference, and thus is transported. The magnetic toner supported on the surface of the developing roller is transported to a side of the elastic blade that is press-contacted with the circumferential surface of the developing roller under a predetermined pressure, and is electrically charged when passing a bottom side of the elastic blade.

The magnetic toner having a predetermined thickness and having been electrically charged when passing the elastic blade, is press-contacted with a surface side of the OPC photosensitive member under a predetermined linear pressure, and thereby the magnetic toner is electrostatically adsorbed into the electrostatic latent image and is contact-developed.

Any one of the OPC photosensitive member and the developing roller is configured to have an elastic surface, such that the magnetic toner is properly press-contacted with the electrostatic latent image during the contact development. For example, at least the surface of the developing roller may be an elastic surface obtained by being made of an elastic material such as urethane or EPDM or the like.

The toner image formed on the surface of the OPC photosensitive member in the above-described manner is further transported to a transferring region in which the transferring charger is opposite thereto and arranged thereon. In the transferring region, a medium to be transferred, such as a sheet of paper or the like is fed between the transferring charger and the toner image in accordance with the transportation of the toner image, and the back side of the medium to be transferred is electrically charged with a polarity reverse to the charged polarity of the toner image by the transferring charger, and thereby the toner image is transferred onto the medium to be transferred.

A corotron or a roller for corona discharging may be used as the transferring charger. Thereafter, the medium to be transferred, onto which the toner image is transferred, is fed to a heating roller unit in which the heating roller and a pressurizing roller are opposite to each other with a predetermined interval. When the medium to be transferred passes through the heating roller unit, the toner image is subjected to pressurizing and heating treatments, and thereby is heat-roller-fixed onto the medium to be transferred. The toner image may be pressure-fixed or oven-fixed.

Meanwhile, the residual developer is removed, by the cleaner, from the surface of the OPC photosensitive member after the toner image is transferred. In the present examples, the blade of a conventional type is used as the cleaner, and the magnetic toner is scraped which remains without being transferred onto the surface of the OPC photosensitive member. Needless to say, the present invention can be applied also to the configuration having no cleaner described above.

Image formation by using the above-described image forming apparatus was performed under the following condition. As the OPC photosensitive member was used a drum-shaped OPC photosensitive member having a diameter of 24 mm, which was rotated at a process speed (VP, also referred to as a peripheral speed) of 120 mm/sec and whose a surface potential (VO) was set at −480 V by using the scorotron. A residual potential (VL) after the surface of the OPC photosensitive member was optical-image-exposed was −30 V.

An urethane rubber roller having a diameter (φ) of 15 mm and a volume resistivity (R) of 250 Ω·cm and containing a conductive agent and a foaming agent was used as the developing roller. This elastic developing roller was press-contacted with the OPC photosensitive member via a toner layer under a pressure (i.e., a linear pressure) of 10 g/cm while being rotated at a peripheral speed of 130 mm/sec slightly higher than the OPC photosensitive member, and thereby the contact development was performed.

Furthermore, the thickness of the layer of the magnetic toner was restricted so as to be 0.03 mm, by using a stainless steel blade as the elastic blade.

Moreover, the toner image was transferred and fixed by using a corotron as the transferring charger, and using a sheet of plain paper as the medium to be transferred, and hot-roller-fixing under a fixing temperature of 180° C. and a fixing pressure with a linear pressure of 1 Kg/cm. In the cleaner, an urethane blade is made to abut against the surface of the OPC photosensitive member at a linear pressure of 5 g/cm after the toner image was the transferred, and then the residual toner was removed.

Next, an explanation will be made of the magnetic toner according to the present invention, the magnetic toner which was applied to the apparatus used in the image forming method based on the non-magnetic one-component developing system having the above-described configuration.

### EXAMPLE 1

The magnetic toner used in Example 1 has the
following composition:

| | |
|---|---|
| Polyester resin (Tg: 64° C.; Tm: 136° C.) | 69 weight parts |
| Polypropylene (NP105) | 4 weight parts |
| Polyethylene (220MP) | 1 weight part |
| Electrification controlling agent (TRH) | 1 weight part |
| Magnetic powder (MAT740) | 25 weight parts. |

In the above-described composition, the magnetic powder was subjected to a surface treatment with a silane coupling agent (SH6040 manufactured by TORAY DOW-CORNING SILICONE).

The respective components listed above were mixed by a Henschel mixer, and were kneaded at a setting temperature of 120° C. by a twin-screw extrusion kneader with a cooler. Thereafter, the kneaded mixture was cooled and crushed by a drum breaker, and further was subjected to a Rotoflex coarse pulverizer. The finely pulverized mixture was pulverized by a rotor-stator type pulverizer Model T250, and lower limit classification thereof was made by a micro flex, and thereby particles, each of which had a volume average particle diameter of 10 μm and a distribution of 5 μm to 15 μm, were obtained.

These particles were mixed by a the Henschel mixer with external additives, that is, 0.5 weight percent of silica (external additive A) which was subjected to a HMDS treatment and had a primary particle diameter of 10 nm, and 0.5 weight percent of silica (external additive B) which was subjected to a HMDS treatment and had a primary particle diameter of 30 nm, and thereby the magnetic toner used in Example 1 was prepared. The magnetic toner obtained had a saturation magnetization σs (10 kOe) of 20.5 (emu/g) and a residual magnetization or of 13.5 (emu/g). An amount of electric charge by blow-off TB200 was −48.5 μc/g.

With using the magnetic toner having the above-described composition, the MICR printing was performed under the conditions described below by the image forming apparatus having the above-described configuration. The result obtained therefrom was shown in Table.

TABLE 1

| | SATURATION | RESIDUAL | MAGNETIC | | | | DURABILITY |
|---|---|---|---|---|---|---|---|
| | MAGNETIZATION | MAGNETIZATION | INTENSITY | | IMAGE | FOG | TEST |
| | σs (emu/g) | σs (emu/g) | (%) * | TEC | DENSITY | (dH) | (FIXING) |
| EXAMPLE 1 | 20.5 | 13.5 | 128 | −48.5 | 1.41 | 0.2 | ◯ |
| EXAMPLE 2 | 17.2 | 13.0 | 122 | −42.3 | 1.39 | 0.1 | ◯ |
| EXAMPLE 3 | 21.1 | 12.2 | 117 | −38.5 | 1.45 | 0.3 | ◯ |
| COMPARATIVE | 30.1 | 16.3 | 102 | −29.1 | 1.05 | 0.6 | ◯ |
| EXAMPLE 1 | | | | | | | |
| COMPARATIVE | 8.3 | 7.0 | 95 | −45.2 | 1.37 | 0.7 | ◯ |
| EXAMPLE 2 | | | | | | | |
| COMPARATIVE | 20.7 | 13.5 | 125 | −51.0 | 1.39 | 0.4 | X |
| EXAMPLE 3 | | | | | | | |
| COMPARATIVE | 21.0 | 13.4 | 107 | −25.1 | 1.25 | 0.3 | ◯ |
| EXAMPLE 4 | | | | | | | |
| COMPARATIVE | 20.3 | 13.3 | 105 | −27.5 | 1.24 | 0.2 | ◯ |
| EXAMPLE 5 | | | | | | | |

*It is preferable that magnetic intensity is 110% or more.

Values of SATURATION MAGNETIZATION and RESIDUAL MAGNETIZATION shown in Table 1 were obtained by encapsulating the toner using a vibration type magnetism measuring device (VSM). Each value of IMAGE DENSITY, that is, the image density obtained by using a reflection density meter (Macbeth RD914) was 1.35 or more, and was preferably 1.40 or more. Values of FOG were represented by the difference (dH) in Hunter whiteness between the white portion of a blank sheet before the printing and the white portion of the printed sheet after the printing in brightness by Hunter. The smaller these values become, the less the fog at the white portion becomes. It is preferable that the values are 0.5 or less.

In order to correctly recognize an MICR font printed by a magnetic reader, the MICR font needs to have a proper magnetic reading strength (i.e., a magnetic intensity, also referred to as “a signal strength”). The standards of the magnetic intensity are determined based on respective nations, and are approximately within a range of 100 to 200%. In Example 1, the lower limit of the magnetic intensity was set at 110%.

### EXAMPLE 2

The magnetic toner used in Exaniple 2 has the
following composition:

| | |
|---|---|
| Polyester resin (Tg: 67° C.; Tm: 140° C.) | 75 weight parts |
| Polypropylene: Biscohol 550P | 2 weight parts |
| Polyethylene: Yumex 110TS | 2 weight parts |
| Electrification controlling agent (T95) | 1 weight part |
| Magnetic powder (KBN400) | 20 weight parts. |

In the above-described composition, the magnetic powder was subjected to a surface treatment with a titanate coupling agent (Plenact TTS manufactured by Ajinomoto Co., Inc.).

The respective components listed above were mixed by a Henschel mixer, and were kneaded at a setting temperature of 140° C. by a twin-screw extrusion kneader with a cooler. Thereafter, the kneaded components were cooled and crushed by a drum breaker, and further were subjected to a Rotoflex coarse pulverizer. The finely pulverized components were pulverized by a rotor-stator type pulverizer Model T250, and lower limit classification was made by a micro flex, and thereby particles each having a volume average particle diameter of 11 μm and a distribution of 5 to 15 μm, were obtained.

These particles were mixed by a Henschel mixer with external additives, that is, 0.5 weight percent of the external additive A, and 0.3 weight percent of titanium oxide (STT30A manufactured by Titan Kogyo Kabushiki Kaisha: an external additive C) having a primary particle diameter of 30 nm, and thereby the magnetic toner used in Example 2 was prepared. The magnetic toner obtained had a saturation magnetization as (10 kOe) of 17.2 (emu/g) and a residual magnetization or of 13.0 (emu/g).

An amount of electric charge by blow-off TB200 was −42.3 μc/g. With using the magnetic toner having the above-described composition, the MICR printing was performed under the same condition as the condition taken in Example 1, by the image forming apparatus having the above-described configuration. The result obtained therefrom was shown above in Table.

### EXAMPLE 3

The magnetic toner used in Example 3 has the
following composition:

| | |
|---|---|
| Styrene-acrylic resin (Styrene n-BA, Tg:62 ° C.; | 75 weight parts |
| Tm: 134° C.) | |
| Polypropylene: Biscohol 550P | 3 weight parts |
| Polyethylene wax (Mitsui High Wax 220MP) | 1 weight part |
| Electrification controlling agent (T2N) | 1 weight part |
| Magnetic powder (KBN400) | 10 weight parts |

| | |
|---|---|
| (KBI20VH) | 15 weight parts. |

The respective components listed above were mixed by a Henschel mixer, and then were kneaded at a setting temperature of 120° C. by a twin-screw extrusion kneader with a cooler. Thereafter, the kneaded components were cooled and crushed by a drum breaker, and further were subjected to a Rotoflex coarse pulverizer. The finely pulverized components were pulverized by a rotor-stator type pulverizer Model T250, and the lower limit classification thereof was made by a micro flex, and thereby particles each having a volume average particle diameter of 10 μm and a distribution of 5 μm to 15 μm, were obtained.

These particles were mixed by the Henschel mixer with external additives, that is, 0.4 weight percent of silica (external additive D) which was subjected to a HMDS treatment and had a primary particle diameter of 7 nm, and 0.4 weight percent of silica (external additive E) which was subjected to a surface treatment with silicone oil and had a primary particle diameter of 30 nm, and thereby the magnetic toner used in Example 3 was prepared.

The magnetic toner obtained had a saturation magnetization σs (10 kOe) of 21.1 (emu/g) and a residual magnetization σr of 12.2 (emu/g). An amount of electric charge by blow-off TB200 was −38.5 μc/g. With using the magnetic toner having the above-described composition, the MICR printing was performed under the same condition as the condition taken in Example 1, by the image forming apparatus having the above-described configuration. The result obtained therefrom was shown above in Table.

Subsequently, a magnetic toners having compositions described below was prepared as several Comparative Examples in order to evaluate the magnetic toners that were used in Examples 1 to 3 and each of which is the present invention. The MICR printing was performed under the same conditions as the respective conditions used in Examples 1 to 3. The results obtained therefrom were shown above in Table.

### Comparative Example 1

A magnetic toner used in Comparative Example 1 had the same component as that in Example 2 except for the composition of the magnetic powder. In the magnetic powder, 35 weight parts of only KBN20VH was used, and thereby the magnetic toner in Comparative Example 1 contained an excessive quantity of magnetic powder. The printing result obtained by using the magnetic toner having the above-described composition was shown in Table. When the content of the magnetic powder became great, an amount of electric charge was small and the image density was reduced in the case of the non-magnetic toner.

### Comparative Example 2

The quantity of the magnetic powder KBN400 contained in the magnetic toner of Example 2 was halved to be 10 weight parts, and thereby the magnetic toner of Comparative Example 2 consisted of the magnetic powder whose the content was lack. The printing result obtained by using the magnetic toner having the above-described composition was shown in Table. When the quantity of the magnetic powder was too small, the magnetic intensity of characters was reduced and thereby it was impossible to correctly recognize the characters by a reader.

### Comparative Example 3

In the magnetic toner of Comparative Example 3, as an external additive, 0.7 weight percent of only the external additive A in the magnetic toner of Example 1 was used. The component of the magnetic toner except this in Comparative Example 3 was the same as that in Example 1. In other words, the magnetic toner in Comparative Example 3 used as an external additive only the external additive containing particles each having a small particle diameter. The printing result obtained by using the magnetic toner having the above-described composition was shown in Table.

### Comparative Example 4

In the magnetic toner of Comparative Example 4, as an external additive, 0.5 weight percent of only the external additive B in the magnetic toner of Example 1 was used. The component of the magnetic toner except this in Comparative Example 4 was the same as that in Example 1. In other words, the magnetic toner in Comparative Example 4 used as an external additive only the external additive containing particles each having a large particle diameter. The printing result obtained by using the magnetic toner having the above-described composition was shown in Table. From above Table 1, it is found that the magnetic intensity was good in the case of using the magnetic toners in Examples 1 to 3 than the case of using the magnetic toners in Comparative Examples except for Comparative Example 3.

### Comparative Example 5

In the magnetic toner of Comparative Example 5, as an external additive, 0.5 weight percent of the external additive B in the magnetic toner of Example 1 and 0.5 weight percent of the external additive C were used. The component of the magnetic toner except this in Comparative Example 5 was the same as the component of the magnetic toner in Example 1. In other words, the magnetic toner in Comparative Example 5 contained two kinds of external additives that were different in material and were substantially the same in volume average particle diameter. The printing result obtained by using the magnetic toner having the above-described composition was shown in Table.

The image density was 1.39 or more in all of Examples 1 to 3, and therefore it was found that the sufficient image density could be achieved. Meanwhile, it was confirmed that the sufficient image density could not be achieved in Comparative Examples 1, 4 and 5.

The fog was 0.3 or less in all of Examples 1 to 3, and therefore it was confirmed that the fog could be satisfactorily suppressed.

As for DURABILITY TEST (FIXING), the favorable results could be similarly achieved in both Examples and Comparative Examples except Comparative Example 3.

The following was verified from the results of Examples and Comparative Examples. Namely, it is found from the results of Examples and Comparative Examples 1 and 2 that the content of the magnetic powder affects the magnetic intensity in the magnetic toner used in the non-magnetic one-component developing system, and therefore holding the content thereof within a certain range is effective in keeping the magnetic intensity within a proper range. In other words, it is found that the range is preferable which is equal to or more than 25 weight parts to less than 35 weight parts in order to keep the magnetic intensity equal to or higher than 115.

Meanwhile, it is confirmed from the results of Examples and Comparative Examples 3 to 5 that the external additive affects the developing property of the magnetic toner. In the case of using only the external additive A containing particles each having a small particle diameter, the magnetic intensity is good, but fixing of the toner to the surface of a sleeve occurs easily. To the contrary, in the case of using only the external additive containing particles each having a large particle diameter, the durability is good, but since the fluidity of the toner is insufficient, the amount of electric charge is small and therefore the image density is reduced. As a result, the magnetic intensity of the characters is reduced. Accordingly, it is inferred from these results that using simultaneously the external additives containing particles having different particle diameters can keep the balance between the durability and the magnetic intensity, thereby holding both good.

From the above-described results, it is confirmed that, by applying, to the image forming method based on non-magnetic one-component developing system, the magnetic toner having the composition according to the present invention, the magnetic toner intensity is good and the image density is proper and the magnetic characters without the fog are formed.

Consequently, with using the magnetic toner according to the present invention, an apparatus to which the non-magnetic one-component developing system is applied can be configured as the MICR printer, thus achieving a much smaller size and a higher speed than the prior art.

According to the present invention, the magnetic toner can be used to form the image well, in the image forming method based on the non-magnetic one-component developing system.

In the present invention, since the magnetic toner can be applied to the non-magnetic one-component image forming method, the magnetic toner can be effectively used in the MICR image formation that prints the magnetic characters. In addition, it is possible to further enjoy the high speed and miniaturization of the apparatus, which are advantages of the non-magnetic one-component developing system.

What is clamed is:

1. A magnetic toner comprising: a magnetic powder; a binder resin; and a wax, wherein the magnetic toner is applied to an image forming method based on a non-magnetic one-component developing system.

2. The magnetic toner according to claim 1, wherein said magnetic toner includes a plurality of kinds of external additives which are different in primary particle diameter and differences of which are within a range of 5 to 50 nm in volume average particle diameter.

3. The magnetic toner according to claim 1 or 2, wherein said magnetic powder has a residual magnetization of 24 to 40 emu/g.

4. The magnetic toner according to any one of claims 1 to 3, wherein the content of said magnetic powder is less than 35 weight percent.

5. The magnetic toner according to any one of claims 1 to 4, wherein said magnetic toner has a residual magnetization of 7 to 20 emu/g.

6. An image forming method comprising a step of forming an image by an image forming method based on a non-magnetic one-component developing system, with using the magnetic toner according to any one of claims 1 to 5.
